(19) United States
(12) Patent Application Publication
(10) Pub. No.: US 2003/0084105 A1
(43) Pub. Date: May 1, 2003

(54) Methods for providing a remote document history repository and multifunction device therefor

(76) Inventors: Jeffrey G. Wiley, Greeley, CO (US); Steve Rossman, Greeley, CO (US); Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/003,818

(22) Filed: Oct. 31, 2001

(51) Int. Cl. G06F 15/16

(52) U.S. Cl. 709/205; 358/400

(57) ABSTRACT

Methods for providing a remote document history repository and multifunction device therefor. Preferred embodiments of the invention may comprise sending a document from a multifunction device, and recording delivery data for the sent document in the remote document history repository when the document is sent from the multifunction device. Accordingly, the delivery data is accessible from the remote document history repository independent of the multifunction device.

### FIELD OF THE INVENTION

The invention generally pertains to document histories, and more specifically, to methods for providing remote document history repositories and multifunction devices therefor.

### BACKGROUND OF THE INVENTION

A multifunction device (MFD) offers a convenient way of communicating with a variety of devices from an individual stand-alone device. Briefly, multifunction devices may be used to convert paper documents to an electronic image and then to transmit the electronic image to a variety of network destinations. For example, the multifunction device may be used to send the electronic image of the paper document to an email account, a facsimile machine, a printer, a copier, an independent software vendor (ISV) application, a mobile phone, and an Internet site, to name but a few such network destinations.

As an illustration, the user may send a paper document to a recipient as follows. The user positions a paper document in the automatic document feeder (ADF) or directly on the imaging bed of the multifunction device. The user then activates the multifunction device, for example, by pressing a “start” button. In turn, the multifunction device converts the paper document to an electronic image thereof. The user may identify a recipient for the electronic image of the paper document. For example, the user may identify a recipient by keying in a facsimile number, an email account, etc., using the keypad of the multifunction device. Or, for example, the user may identify a recipient by selecting the same from a menu or address book shown on the display at the multifunction device. The multifunction device then sends the electronic image of the paper document over a suitable network (e.g., the Internet, an intranet) to the recipient at any of a number of various network destinations.

In various circumstances, the user may need to resend a document after it has already been sent from the multifunction device. For example, the document may become lost or corrupted during transmission, or after it arrives at its final destination. Or, for example, the document size may exceed the maximum capacity allowed by the recipient's server, and therefore the document may be “bounced” (i.e., returned to the user).

Accordingly, the user may manually resend the document by again imaging the document, entering the recipient's address, and sending it from the multifunction device. However, this is time-consuming and renders the multifunction device unavailable for others to use. Alternatively, the user may send a copy of the document to the user's email account using the carbon copy (cc), or blind carbon copy (bcc) function, and thus have the document available to resend from the user's email if it should become necessary to do so. However, this likely creates individual, user-specific archives as opposed to one or more central archives. In addition, this is time-consuming, and is also prone to human error, such as when the user does not send a copy to him or herself.

In other circumstances, the user or an administrator may want to determine the status of the multifunction device and/or the documents sent therefrom. In one such circumstance, the user may want to confirm that a document was indeed sent from the multifunction device. Where the multifunction device encountered an error, such as a voice recording while attempting to send a facsimile, the user may need to confirm that he or she entered the correct facsimile number and then he or she may choose to resend the document. In another such circumstance, an administrator may want to monitor, and troubleshoot when necessary, one or more multifunction devices. Where the multifunction device is unable to send any documents to facsmile machines, the administrator may check that the multifunction device is connected to a phone line.

Accordingly, a log may be stored in memory at the multifunction device for recording information related to documents delivered therefrom. The user and/or an administrator may access the log at the multifunction device itself, or using suitable software for accessing the same over a network. However, the disadvantages of this type of log stem in part from the need to make more memory available to the multifunction device for other operations. That is, only a limited quantity of memory is dedicated to storing this type of log at the multifunction device. Therefore, this type of log typically only includes basic information, such as the type of device that the document was sent to (e.g., an email account, a facsimile machine, etc.), the time that the document was sent, and whether the document was successfully sent from the multifunction device or whether it encountered an error. Thus, the user or administrator can only make limited assessments of the multifunction device and/or the documents delivered therefrom.

Another disadvantage of this type of log is its temporary nature, again driven in part to make more memory available to the multifunction device for other operations. That is, this type of log typically only includes information for a few jobs, and in any event, any information that is included therein is only maintained in memory for a short duration of time. For example, these logs may only include the most recent sent jobs, and the “oldest” jobs may be deleted from the log as new jobs are added. Or, for example, these logs may be erased hourly or at the end of the day.

Yet another disadvantage of this type of log is the accessibility thereof. Because the log is stored in memory at the multifunction device itself, when the multifunction device is unavailable (e.g., when it is powered down or otherwise taken offline) the log is also inaccessible. In addition, if an administrator wants to monitor more than one multifunction device, the administrator must independently access the log from each multifunction device.

### SUMMARY OF THE INVENTION

Multifunction device for providing a remote document history repository may comprise application software on a computer-readable media for recording delivery data in a remote document history repository when a document is sent from the multifunction device.

Embodiments of methods for providing a remote document history repository may comprise the steps of: sending a document from a multifunction device, and recording delivery data for the sent document in the remote document history repository when the document is sent from the multifunction device. Accordingly, the delivery data is accessible from the remote document history repository independent of the multifunction device.

Other embodiments of methods for providing a remote document history repository may comprise the steps of: sending an electronic document from a multifunction device, and recording delivery data for the sent electronic document in the remote document history repository after the electronic document is sent from the multifunction device. Accordingly, the delivery data is accessible from the remote document history repository independent of the multifunction device.

### BRIEF DESCRIPTION OF THE DRAWINGS

Illustrative and presently preferred embodiments of the invention are illustrated in the drawings, in which:

FIG. 1 is a high-level diagram illustrating an embodiment of a multifunction device for providing a remote document history repository;

FIG. 2 is a high-level diagram illustrating another embodiment of a multifunction device for providing a remote document history repository;

FIG. 3 is a high-level process flow diagram illustrating components for providing a remote document history repository;

FIG. 4 illustrates an embodiment of an interface for accessing a remote document history repository; and

FIG. 5 is a flow chart illustrating an embodiment of methods for providing a remote document history repository.

### DESCRIPTION OF THE PREFERRED EMBODIMENT

Multifunction device 100 is shown and described herein as it may be used for providing a remote document history repository 150 according to the teachings of the invention. Briefly, multifunction devices 100 may be used to convert paper documents 110 to electronic images and then transmit the electronic images to a variety of destinations 140-142 including, but not limited to, an email account 140, a facsimile machine 141, and/or any number of other devices or communication services 142, now known or later developed, such as a printer, copier, personal computer (PC), independent service vendor (ISV) application, mobile phone, personal digital assistant (PDA), Internet web page, to name a few.

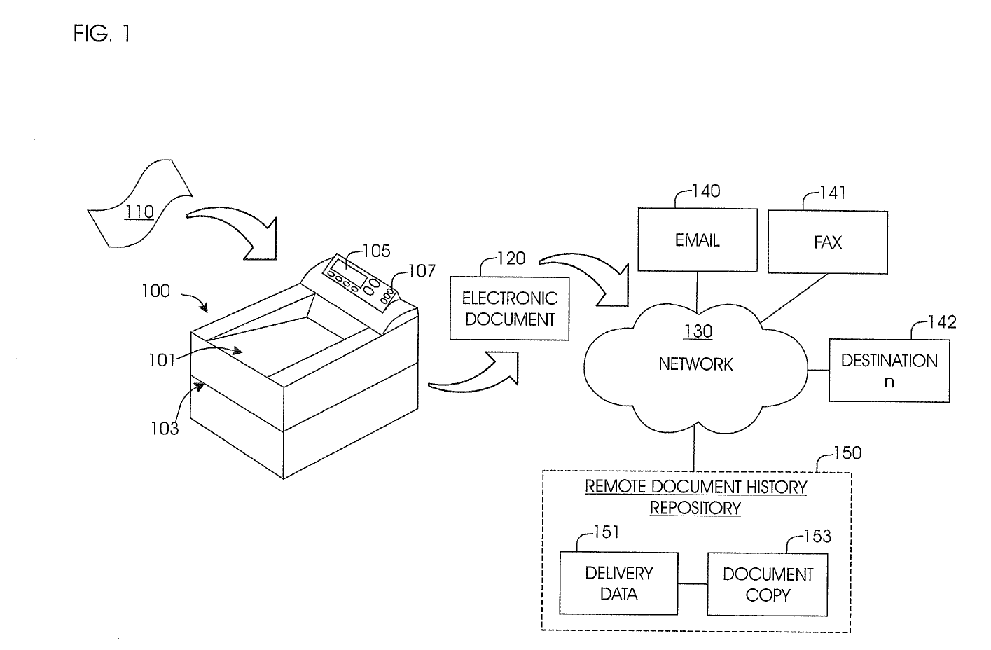

According to the teachings of the invention, an embodiment of a multifunction device 100 for providing a remote document history repository 150 is shown and described with respect to FIG. 1. The multifunction device 100 may comprise computer-readable media operatively associated therewith and having application software (i.e., computer-readable program code) thereon. The computer-readable media may comprise one or more of any suitable media, as explained in more detail below. Likewise, the computer-readable program code may reside on the computer-readable media in any suitable manner, also as explained in more detail below. The application software may include program code for recording delivery data 151 in the remote document history repository 150 when the document 110 is sent from the multifunction device 100.

The multifunction device 100 may be operated as follows, according to one embodiment of the invention, for providing a remote document history repository 150. A document 110 may be sent from a multifunction device 100. When the document 110 has been sent, delivery data 151 for the sent document 110 is preferably recorded in the remote document history respository 150. The delivery data 151 may therefore be accessed from the remote document history repository 150 independent of the multifunction device 100.

The remote document history repository 150 of the present invention is not stored at the multifunction device 100, but is instead stored remotely therefrom. Accordingly, the remote document history repository 150 is not constrained by the multifunction device's memory requirements. The remote document history repository 150 may thus comprise more comprehensive delivery information 151, and may be indefinitely retained. Likewise, the remote document history repository 150 is accessible regardless of the current state of the multifunction device 100, even when it is shut down or otherwise unavailable. According to other embodiments of the invention, the remote document history repository 150 may also include a copy 153 of the sent document, and therefore enables the user to resend a document 110 by sending the copy 153 thereof without having to rescan and retransmit the document 110 using the multifunction device 100.

The multifunction device 100 may be used to convert a “paper” document 110 to an electronic document 120. For example, the user may place the document 110 in the automatic document feeder (ADF) 101, or directly on the imaging bed 103 of the multifunction device 100, wherein the paper document 110 is electronically imaged. The electronic document 120 may be sent from the multifunction device 100 via a suitable network 130 (e.g., the Internet, an intranet, a combination thereof, telephone network, etc.) to the recipient at one or more destinations 140-142. Preferably, delivery data 151 (e.g., the user, the document summary, the recipient, the number of pages of the document, the identity of the multifunction device 100, a time-stamp, a date-stamp, etc.) for the sent document is recorded in the remote document history repository 150. In other embodiments, the multifunction device 100 also copies the document (i.e., the electronic image thereof) to the remote document history repository 150 and/or to another network site as explained below. As such, the delivery data 151 and/or the document copy 153 may be accessed from the remote document history repository 150 after the document 110 has been sent from the multifunction device 100.

According to preferred embodiments of the invention, computer-readable media may be operatively associated with the multifunction device 100 having computer-readable program code thereon. The computer-readable media may comprise any suitable media that is now known or is later developed. For example, the computer-readable media may comprise media such as attached storage (e.g., a hard disk drive), random access memory (RAM), removable media (e.g., a compact disc (CD)), etc. In addition, it is understood that the computer-readable program code may comprise a software application, an executable file (e.g., an applet), routines, subroutines, etc. Indeed, the computer-readable program code may access other computer-readable program code for performing one or more tasks. In addition, the computer-readable program code may be stored in whole on a single computer-readable medium, or various components of the computer-readable program code may be stored on more than one computer-readable media. Preferred embodiments of the computer-readable program code are explained in more detail below.

Before continuing, the following definitions are provided to further describe the invention. The terms “printed” document and “paper” document (i.e., document 110), as used interchangeably herein, are intended to encompass any document that may be converted to electronic format using the multifunction device 100. For example, such a document may comprise photocopies, printed-paper, photographs, slides, viewgraphs, color documents, black/white documents, objects (e.g., a side thereof), etc. In addition, more than one paper document 110 may be converted to electronic format. For example, one or more pages of the paper document 110 may be imaged using the ADF 101, or using the imaging bed 103.

In addition, the document in “electronic format” or the “electronic document” preferably comprises a header, a message, and an electronic image of the document 110. The header preferably identifies routing information for the electronic document 120, such as a recipient, a user, and any other suitable information in any suitable format. The message may be included for conveying additional information to the recipient. Although the message may take any suitable format, it preferably includes instructional text or identifying information, much like that which may be included on a facsimile cover sheet. The electronic image of the document 110 is preferably formatted so that it may be viewed with readily-available software (e.g., ADOBE® READER®, a web browser) or converted for output from a readily-available device (e.g., another multifunction device, a facsimile machine, a printer, a photocopier).

In one preferred embodiment, the multifunction device 100 is an HP DIGITAL SENDER™ 9100C (Hewlett-Packard Company, Palo Alto, Calif.). The HP DIGITAL SENDER™ 9100C can send documents to Internet email accounts, facsimile machines, to PCs (e.g., for viewing or editing with suitable software applications), to a network folder, etc. In another embodiment, the multifunction device 100 may comprise a multifunction peripheral (MFP), such as the HP OFFICE JET® G95 available from Hewlett-Packard Company. The HP OFFICE JET® G95 can print, copy, fax, and scan documents. However, it is understood that any suitable multifunction device, now known or later developed, may be used according to the teachings of the embodiments of the invention. Indeed, it is understood that in other embodiments, the multifunction device 100 may be another multifunction device or multifunction peripheral, a network digital copier, an “all-in-one” device for attachment to a PC, a document management machine, a network-capable scanner, etc. Accordingly, the present invention should not be regarded as limited to use with the particular multifunction device 100 shown and described herein.

The multifunction device 100 may send documents to any suitable destination device or service 140, now known or later developed, and is not limited to those shown and described with respect to FIG. 1. In addition, while the multifunction device 100 is preferably enabled for connection to a Transmission Control Protocol/Internet Protocol (TCP/IP) network 130, the multifunction device 100 may be connected over any suitable network or networks, including but not limited to, a local area network (LAN), a wide area network (WAN), a secure network, an intranet, the Internet, a telephone network, a combination thereof, etc. Likewise, the multifunction device 100 may be connected to the network 130 in any suitable manner, including but not limited to a hardwired connection, an infrared connection, via satellite, via dial-up connection (i.e., using a modem), a dedicated connection (e.g., cable, digital subscriber line (DSL), T-1, T-3), etc.

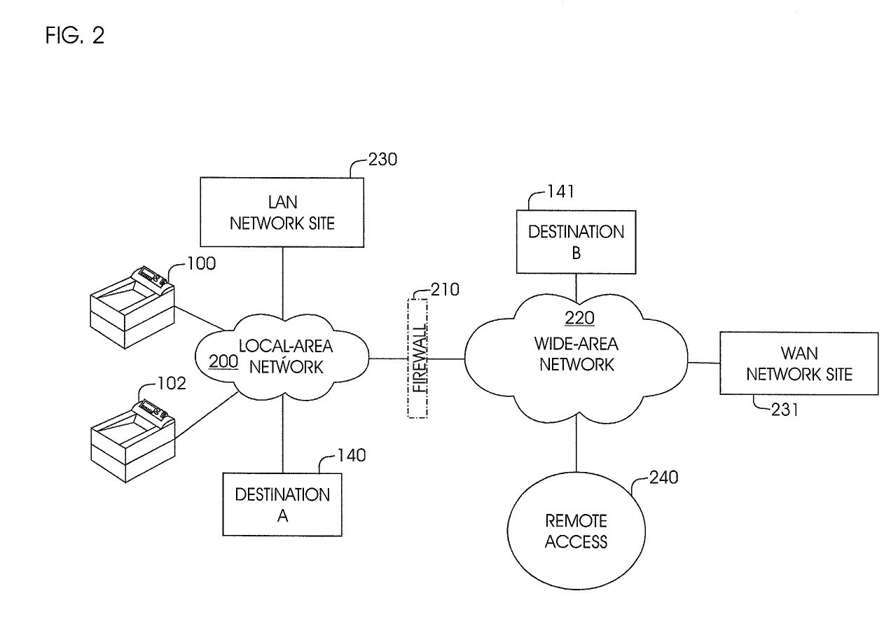

Another embodiment of the multifunction device 100 is illustrated in FIG. 2. As discussed above, the paper document 110 may be converted to electronic format, which may be sent from the multifunction device 100 to a destination 140 on the network 130. As an illustration, the electronic document 120 may be sent from the multifunction device 100 over local area network (LAN) 200 to Destination A (140). Alternatively, or in addition to, the electronic document 120 may be sent from the multifunction device 100 over the wide area network (WAN) 220 to Destination B (141).

In any event, the delivery data 151 is preferably sent to a remote document history repository 150, as discussed above with respect to FIG. 1. Likewise, the document 110 may be copied to the remote document history repository 150 (i.e., document copy 153). In one embodiment, the remote document history repository 150 may reside on a LAN network site 230 (e.g., at a server on the corporate intranet). As such, the remote document history repository 150 may be maintained behind an extra layer of security (e.g., firewall 210). Alternatively, the remote document history repository 150 may reside on a WAN network site 231 (e.g., an Internet site). As such, the remote document history repository 150 may be readily accessed from other terminals 240 on the WAN (e.g., any Internet terminal). Preferably, even when the remote document history repository 150 is stored at a WAN network site 231, appropriate security measures (e.g., passwords, encryption, etc.) are implemented to prevent unauthorized access thereto.

It is understood that the embodiment of the network configuration shown in FIG. 2, and the illustrations with respect thereto, are merely exemplary and are not intended to limit the scope of the invention thereto. In another embodiment the multifunction device 100 may be used to send the same document 110 to more than one destination (e.g., Destination A and Destination B). In yet another embodiment, the multifunction device 100 may reside on the WAN 220, and the remote document history repository 150 may be stored on the LAN network site 230 and/or the WAN network site 231. In yet another embodiment, a plurality of multifunction devices 100, 102 may reside at various places on the networks 200, 220. Preferably, in such an embodiment, each of the multifunction devices 100, 102 record delivery data 151 in a single remote document history repository 150. Accordingly, an administrator may access one remote document history repository 150 to monitor each of the multifunction devices 100, 102. However other embodiments of the network configuration are also contemplated as being within the scope of the invention.

According to any of these embodiments of the various network configurations, the delivery data 151 and/or the document copy 153 may be accessed from the remote document history repository 150 (e.g., at network site 230, 231) even after it has been sent from the multifunction device 100, as described in more detail below.

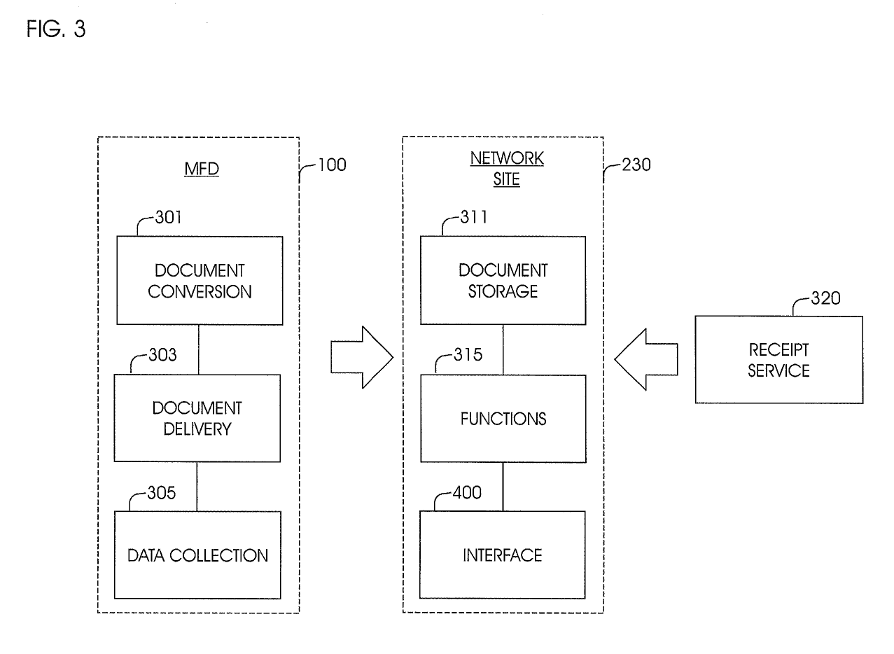

The multifunction device 100 is preferably embodied in computer-readable program code, hardware, or a combination thereof, as illustrated in FIG. 3. For purposes of illustration, the components are shown grouped according to where each component may reside in a preferred embodiment of the invention. That is, the document conversion 301, document delivery 303, and data collection 305 components preferably reside on the multifunction device 100, while the document storage 311, functions 315, and program code for the interface 400 preferably reside at network sites 230, 231, and the receipt service 320 preferably resides elsewhere on the network 130 separately from either the multifunction device 100 and the network sites 230, 231. However, it is understood that the invention is not limited to such a grouping of the various components.

The multifunction device 100 may be provided with a document conversion component 301, a document delivery component 303, and a data collection component 305. The document conversion component 301 may comprise scanning or imaging hardware and software. Also preferably, the document conversion component 301 comprises program code for assembling the electronic document 120, and optionally, for copying the document 110 to the remote document history repository 150. The document delivery component 303 may comprise hardware and software for connecting to the network 130, and for sending the electronic document 120 from the multifunction device 100 over the network 130. The data collection component 305 preferably receives, collects, or otherwise determines the delivery data 151 for the documents 110 sent from the multifunction device 100, and sends the delivery data 151, and optionally the document copy 153, to the remote document history repository 150. For example, the data collection component 305 may comprise program code for reading a system clock to determine the time that the document 110 was sent from the multifunction device 100, program code for determining transmission data (e.g., user, recipient, etc.), program code for determining document data (e.g., file size, file name, number of pages, etc.), and program code for determining any other suitable delivery data 151 (e.g., whether a receipt was requested).

According to preferred embodiments of the invention, the delivery data 151 is recorded in the remote document history repository 150 transparently to the user. Likewise, where the document 110 is copied to the remote document history repository 150, this is also transparent to the user. That is, the user preferably only needs to specify a recipient and position the paper document 110 in the ADF 101 or directly on the imaging bed 103, and activate the multifunction device 100. Then with few, if any, additional steps required by the user, the multifunctional peripheral 100 images the paper document 110, sends the electronic document 120 to a destination, and records delivery data 151 to the remote document history repository 150. According to other preferred embodiments of the invention, the paper document 110 may also be copied to the remote document history repository 150.

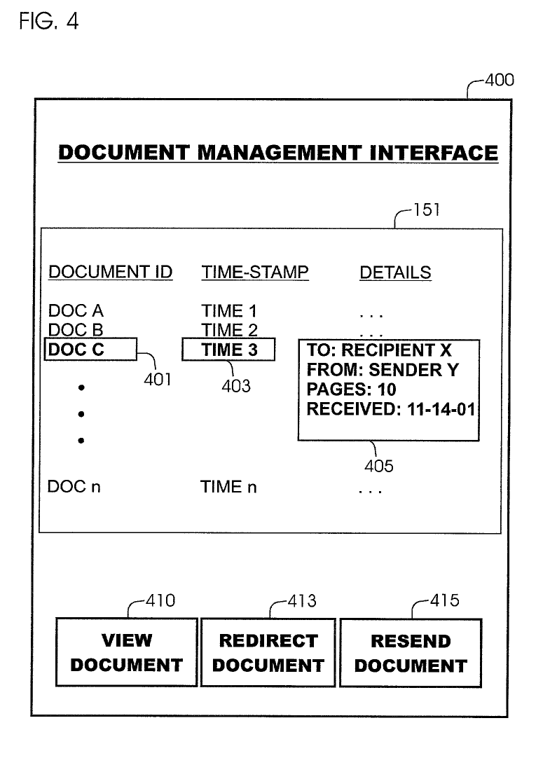

The network site 230, 231 may be provided with document storage 311, functions 315, and an interface 400. The document storage component 311 preferably comprises computer-readable storage media (e.g., one or more hard disk drives, compact discs (CDs), network attached storage (NAS) devices, storage area networks (SANs), etc.). The document storage component 311 preferably also comprises program code for storing or recording and retrieving the delivery data 151, and optionally the document copy 153, on the storage media. The functions 315 preferably comprise program code for accessing the remote document history repository 150. Preferably, the remote document history repository 150 and the functions 315 may be accessed by a user or an administrator via the interface 400, discussed in more detail below with respect to FIG. 4.

As discussed above, the remote document history repository 150 may comprise the delivery data 151 and/or the document copy 153. In various circumstances, for example where storage capacity is limited or where a large volume of documents are sent from the multifunction device 100, the document copy 153 may comprise only the first page, a summary of the document, etc. Alternatively, document copies 153 may only be recorded in the remote document history repository 150 on a limited basis (e.g., only those sent within the past week or month). According to such an embodiment, the documents may be purged after a predetermined time, or until more storage capacity is made available. Also alternatively, the document copy 153 may be omitted altogether and only the document delivery data 151 may be recorded in the remote document history repository 150. Preferably, an administrator may configure the multifunction device 100 accordingly.

A receipt service 320 may be provided for use with the remote document history repository 150. The receipt service 320 is preferably program code residing at another site on the network (e.g., LAN 200, WAN 220) for tracking receipt of a document sent from a multifunction device 100. In one embodiment, suitable program code may be provided to read a return receipt sent from the recipient, and to format the information therein for use with the remote document history repository 150. For example, information such as the time that the electronic document 120 was received at the destination 140, whether it has been read, the identity of the recipient, etc., may be suitably formatted and included with the delivery information 151 in the remote document history repository 150.

More specifically, program code may be provided for updating the remote document history repository 150 when a receipt is received (e.g., from receipt service 320) to acknowledge that the intended recipient received the document 110. For example, when a document 110 is sent from the multifunction device 100 at 12:00 p.m., and the receipt service 320 acknowledges receipt of the document 110 at the intended destination at 3:00 p.m., program code may update the delivery data 151 in the remote document history repository 150 to indicate that the document was received at 3:00 p.m.

In addition, program code may be provided for resending the document (i.e., document copy 153) after a predetermined time has elapsed since the document 110 was sent from the multifunction device 100, as indicated by the lack of a return receipt. For example, when a document 120 is sent from the multifunction device 100 at 12:00 p.m., and the remote document history repository 150 has not been updated to indicate receipt thereof by 5:00 p.m., the program code may notify the user that the intended recipient has not yet received the document 110. Also for example, when a document 110 is sent from the multifunction device 100 on Monday, and the remote document history repository 150 has not been updated to indicate receipt thereof on Wednesday, the program code may automatically resend the document (i.e., document copy 153). Indeed, in this example, the program code may even increase the priority of the document 110 when it is resent. Alternatively, the program code may instead send an email or other notification (e.g., a facsimile, pager alert, etc.) to the sender to notify the sender that the document is undeliverable.

It is understood that the embodiments of the various components shown and described with respect to FIG. 3 are merely illustrative, and are not intended to limit the scope of the invention thereto. For example, an identification component (not shown) may also be provided and may comprise program code for identifying the multifunction device 100 from which the document 110 is sent. According to such an embodiment, an administrator may monitor a plurality of multifunction devices 100, 102 (FIG. 2) based on the identity of each recorded in the remote document history repository 150.

An interface 400, such as may be used to access the delivery data 151 and/or the document copies 153 from the remote document history repository 150, is illustrated in FIG. 4. In one embodiment, the interface 400 may be one or more Internet web pages (e.g., hypertext markup language (HTML) pages) for display with an Internet browser. In another embodiment, the interface 400 may be a software application with program code for accessing the remote document history repository 150. Other embodiments of the interface 400 are also contemplated as being within the scope of the invention. For example, in other embodiments, the remote document history repository 150 may be accessed via the multifunction device 100, a PC, a mobile phone, a PDA, etc. In any event, suitable program code is preferably provided for accessing the delivery data 151 and/or the document copies 153 from the remote document history repository 150 as requested by the user (e.g., via the interface 400).

The interface 400 preferably comprises a window for displaying the delivery data 151. The delivery data 151 may comprise document identification 401, a corresponding time-stamp 403 indicating when the document 110 was sent from the multifunction device 100, and any number of other details 405. Preferably, the delivery data 151 is displayed in a readily understood, easy-to-use environment. For example, the delivery data 151 may be provided in a “point-and-click” window environment, such as that shown in FIG. 4. It is understood, however, that the delivery data 151 may be presented according to other suitable formats. For example, the delivery data 151 may be presented as text (as shown in FIG. 4), as charts, icons, or other graphics (not shown), an audible voice message, a multimedia presentation, etc.

Preferably, the document identification 401 is provided so that a user accessing the remote document history repository 150 may readily identify the documents 110 sent from the multifunction device 100. Preferably the document identification 401 may comprise a job identity or a user-specified identification. It is understood, however, that the document identification 401 may comprise any suitable information for identifying the documents 110 sent from the multifunction device 100.

Preferably the time-stamp 403 indicates the time (e.g., date, hour, minute, etc.) that the document 120 was sent from the multifunction device 100. However, the time-stamp 403 may indicate the time that the user delivered the document 110 to the multifunction device 100. Likewise, the time-stamp 403 may indicate both the time that the document 110 was delivered to the multifunction device 100 and when it was sent from the multifunction device 100. Preferably, both times are indicated when there is a delay before the document is sent. By way of example, both times may be indicated when the document 120 is first placed into a queue before it is sent; when the connection is busy and the multifunction device 100 must retry the connection; when there is a power failure; or when there is a user-requested delay.

Preferably, the user may select a job (e.g., by clicking on the document identification 401 using a PC mouse) to view the details 405 thereof. As an illustration, the user may position the cursor over the document identification 401, and “click” with the PC mouse to select the same. For example, “DOC C” is shown selected in FIG. 4, as indicated by the boldface type. When a job is selected, the details 405 are preferably shown in expanded form. The details 405 may comprise any suitable details, such as the recipient, the user, the number of pages sent, if the document 110 is still in a queue, whether and when the document 120 was received, the type of job (e.g., email, facsimile), any failures or errors, document properties (e.g., color, black and white, file type), identity of originating multifunction device, etc.

Also in a preferred embodiment of the invention, suitable program code may be provided for various functions for managing the documents 120 sent from the multifunction device 100. These functions may comprise, but are not limited to, a view function (e.g., designated by button 410 in FIG. 4), a redirect function (e.g., designated by button 413 in FIG. 4), and/or a resend function (e.g., designated by button 415 in FIG. 4). These functions are explained in more detail below to illustrate various embodiments of the invention. However, still other functions are also contemplated as being within the scope of the invention. For example, program code may be provided for various edit functions, enhancement functions, etc.

As just discussed, program code may be provided for viewing a document 110 (i.e., the document copy 153) even after it has been sent from the multifunction device 100. For example, the user may select a job as described above, and “click” on the view button 410 using the PC mouse. In response, program code preferably accesses the document copy 153 (e.g., from a storage depository) corresponding to the selection, and displays it using suitable display software, such as ADOBE® READER®.

In another embodiment, program code may be provided for redirecting a document 110 (i.e., the copy 153 thereof) from the remote document history repository 150. For example, the user may select a document as described above, and “click” on the redirect button 413 using the PC mouse. In response, program code preferably accesses the document copy 153 (e.g., from a storage depository) corresponding to the selection, prompts the user for a newly designated recipient (e.g., an email account, facsimile number, etc.), and sends the document copy 153 using suitable transmission software.

In yet another embodiment, program code may be provided for resending a document 110 (i.e., the copy 153 thereof) from the remote document history repository 150. For example, the user may select a job as described above, and “click” on the resend button 415 using the PC mouse. Program code accesses the document copy 153 (e.g., from a storage depository) corresponding to the selection, and sends it to the designated recipient (e.g., an email account, facsimile number, etc.) previously identified when the document 110 was originally sent from the multifunction device 100. Again, suitable transmission software may be used to resend the document.

It is understood that program code may be provided for other functions not shown in FIG. 4. In another embodiment, program code may be provided for automatically resending or redirecting the document copy 153. For example, program code may be provided for automatically resending the document when there is a send failure, thereby releasing the multifunction device 100 to send other documents 110. Or for example, when the recipient's email server bounces the document 120 (e.g., when it exceeds a maximum file size), program code may be provided for receiving the “bounced” message from the email server and for notifying the intended recipient that the document copy 153 is available at the network site 230, 231 (e.g., via remote document history repository 150). In such an embodiment, appropriate security measures may be provided so that the intended recipient only has access to the intended document copy 153, and does not necessarily have access to the entire remote document history repository 150. In yet another example, program code may be provided to send some or all of the delivery data 151 to an administrator on a regular basis (e.g., daily, monthly, upon request, etc.). Still other functions for managing the documents 110 sent from the multifunction device are also contemplated as being within the scope of the invention.

It is also understood that the embodiments for accessing the remote document history repository 150 shown and described with respect to FIG. 4 are merely exemplary, and are not intended to limit the scope of the invention thereto. Other embodiments of the interface 400 may comprise one or more toolbars (not shown) for activating the various functions. Still other embodiments of the interface 400 may comprise one or more windows for displaying various delivery data. For example, a different interface may be displayed for a user than is displayed for an administrator. The user may only have access to documents the user sent, while the administrator may have access to all of the documents sent from a plurality of multifunction devices 100, 102 and to the usage statistics thereof. In yet other embodiments for accessing the remote document history repository 150, the delivery data 151 may be compiled with links (e.g., via uniform resource locator (URL)) and sent to the user, for example, as a text file sent via email.

It is readily apparent that the remote document history repository 150 may be used according to the teachings of the invention in any number of ways. For example, the remote document history repository 150 may be accessed to manage or track document flow. In one such embodiment, an administrator may access the remote document history repository 150 to monitor the number of confidential documents sent, to whom each confidential document was sent, and whether the intended recipients received each of the confidential documents. As another example, the user may remotely access the remote document history repository 150 to discuss the same with the recipient after the user has left the office or otherwise no longer has access to the original document 110. As yet another example the remote document history repository 150 may even be used for disaster recovery to retrieve a destroyed or an otherwise unavailable file.

According to an embodiment where the remote document history repository 150 includes administrative features, the administrator may even access the remote document history repository 150 to manage one or more of the multifunction devices 100, 102. For example, the administrator may select a multifunction device 100 from the interface 400, sort the delivery data 151 by the user identity, and determine usage patterns for various of the multifunction devices 100, 102 and/or the users thereof. For example, where a first department is using a multifunction device 100 on a continual basis and a second department rarely uses their multifunction device 102, the administrator may have the second multifunction device 102 relocated to the first department. Likewise, the administrator may configure one or more of the multifunction devices 100, 102. For example, the administrator may limit or block destinations for multifunction devices 100, 102 stationed in departments working on highly sensitive or confidential matters. Yet other uses and advantages will be apparent to those skilled in the art based on the teachings of the invention.

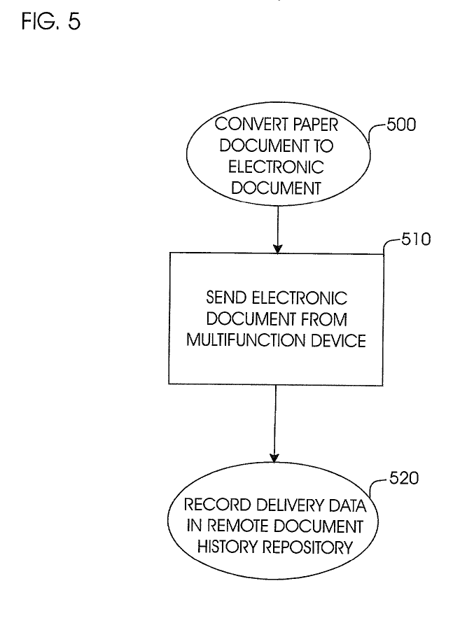

An embodiment of methods for providing a remote document history repository may be illustrated with reference to the flow chart in FIG. 5. According to this embodiment, a paper document 110 is preferably converted to an electronic document 120 at a multifunction device 100, as shown in step 500. The electronic document 120 may then be sent from the multifunction device 100, as shown in step. 510. For example, the document may be sent to one or more of the network destinations 140-142. In any event, delivery data 151 for the sent electronic document 120 is preferably recorded in a remote document history repository 150 when the electronic document 120 is sent from the multifunction device 150, as shown in step 520. Accordingly, the delivery data 151 may be accessed from the remote document history repository 150 (e.g., at a network site 230, 231.

It is understood that the steps shown and described in FIG. 5 are merely illustrative of a preferred embodiment of methods for providing a remote document history repository 150. In another embodiment, the methods for providing a remote document history repository 150 may instead comprise the steps of sending a document 110 from a multifunction device 100, and recording delivery data 151 for the sent document in a remote document history repository 150 when the document 110 is sent from the multifunction device 100, wherein the delivery data 151 is accessible from the remote document history repository 150 independent of the multifunction device 100.

Other embodiments of the method are also contemplated as being within the scope of the invention. For example, the steps need not be performed in the order shown in FIG. 5. Also for example, one or more steps may be modified. Also for example, the same steps may be performed in more than one manner according to various embodiments of the invention.

What is claimed is:

1. A method for providing a remote document history repository, comprising:
sending a document from a multifunction device; and
recording delivery data for said sent document in said remote document history repository when said document is sent from said multifunction device, wherein said delivery data is accessible from said remote document history repository independent of said multifunction device.

2. The method of claim 1, further comprising accessing said remote document history repository to track document flow.

3. The method of claim 1, wherein sending said document is from a multifunction device selected from the group consisting of: a multifunction peripheral, a network digital copier, an “all-in-one” device for attachment to a PC, a document management machine, and a network-capable scanner.

4. The method of claim 1, further comprising updating said remote document history repository to indicate receipt of said sent document.

5. The method of claim 1, further comprising copying said document to said remote document history repository.

6. The method of claim 5, further comprising resending said document by sending said copied document from said remote document history repository.

7. The method of claim 5, further comprising redirecting said document by sending said copied document from said remote document history repository to another recipient.

8. The method of claim 1, further comprising copying said document to a network site.

9. The method of claim 8, further comprising notifying an intended recipient of said document that said copied document is available from said network site.

10. The method of claim 1, further comprising notifying a sender of said document that said document is undeliverable.

11. The method of claim 1, further comprising:
monitoring receipt of said document; and
resending said document after a predetermined time based on said delivery data recorded in said remote document history repository.

12. The method of claim 1, wherein at least the step of recording said delivery data is transparent to a user of said multifunction device.

13. The method of claim 1, further comprising converting a paper document to an electronic document at a multifunction device for sending therefrom.

14. A method for providing a remote document history repository, comprising:
sending an electronic document from a multifunction device; and
recording delivery data for said sent electronic document in said remote document history repository after said electronic document is sent from said multifunction device, wherein said delivery data is accessible from said remote document history repository independent of said multifunction device.

15. The method of claim 14, further comprising updating said remote document history repository to indicate receipt of said sent electronic document.

16. The method of claim 14, further comprising copying said electronic document to a network site.

17. The method of claim 16, further comprising notifying an intended recipient of said electronic document that said copied electronic document is available from said network site.

18. The method of claim 14, further comprising notifying a sender that said electronic document is undeliverable.

19. The method of claim 14, further comprising:
monitoring receipt of said electronic document; and
resending said electronic document after a predetermined time based on said delivery data recorded in said remote document history repository.

20. A multifunction device comprising application software on a computer-readable media for recording delivery data in a remote document history repository when a document is sent from said multifunction device.

21. The multifunction device of claim 20, wherein said application software records at least an identity of said multifunction device and an identity of said document sent therefrom in said remote document history repository.

22. The multifunction device of claim 20, wherein said application software copies said document to said remote document history repository.

23. The multifunction device of claim 22, wherein said application software further comprises an interface for accessing said document copied to said remote document history repository.

24. The multifunction device of claim 20, wherein said application software further comprises an interface for displaying said delivery data.
